(19) United States
(12) Patent Application Publication
(10) Pub. No.: US 2021/0099612 A1
(43) Pub. Date: Apr. 1, 2021

(54) METHOD AND SYSTEM FOR SECURE SCAN AND COPY

(71) Applicant: Konica Minolta Business Solutions U.S.A., Inc., Ramsey, NJ (US)

(72) Inventors: Masayuki TASHIRO, San Mateo, CA (US); Rakesh PANDIT, San Mateo, CA (US)

(73) Assignee: Konica Minolta Business Solutions U.S.A., Inc., Ramsey, NJ (US)

(21) Appl. No.: 16/585,109

(22) Filed: Sep. 27, 2019

(51) Int. Cl. H04N 1/44; H04N 1/00; H04L 29/06; H04N 1/32

(52) U.S. Cl. CPC H04N 1/444; H04N 1/0048; H04N 1/32144; H04L 63/101; H04N 1/4433

(57) ABSTRACT

A method, a non-transitory computer readable medium, and a system are disclosed for method securing printed documents from being scanned or copied on a multi-function printer. The method includes collecting user attributes from a user upon accessing the multi-function printer; collecting information from the multi-function printer; extracting information from a printed document being scanned or copied; analyzing the user attributes collected from the user, the information collected from the multi-function printer, and the information extracted from the printed document; and determining whether the user is authorized to execute a scan job or a copy job of the printed document on the multi-function printer based on the information collected from the multi-function printer, and one or more of the user attributes collected from the user, and the information extracted from the printed document.

### FIELD OF THE INVENTION

The present disclosure generally relates to a method and system for secure scan and/or copy on a multi-function printer, and more particularly, a method and system for secure scan and/or copy on a multi-function printer by analyzing a combination of history and other information, for example, related to user information and/or document information.

### BACKGROUND OF THE INVENTION

Current security for scan/copy on multi-function printers is based on document information. Multi-function printers are used in the office by internal and/or external users and as a result, potential security risks exist when scan/copy is performed by either the internal and/or external users. For example, internal users may send (or copy & hand) documents including confidential information to non-appropriate person, external users may send (or copy & hand) documents including confidential information to non-appropriate person, and/or internal users' security settings may not be updated correctly.

### SUMMARY OF THE INVENTION

In consideration of the above issues, it would be desirable to have a method and system for secure scan and/or copy by providing appropriate security system/settings by analyzing a combination of history and other information (user information and/or document information) instead of using only document information. By providing this, user's security level to these operations can be significantly improved.

In accordance with an exemplary embodiment, a method is disclosed of securing printed documents from being scanned or copied on a multi-function printer, the method comprising: collecting user attributes from a user upon accessing the multi-function printer; collecting information from the multi-function printer; extracting information from a printed document being scanned or copied; analyzing the user attributes collected from the user, the information collected from the multi-function printer, and the information extracted from the printed document; and determining whether the user is authorized to execute a scan job or a copy job of the printed document on the multi-function printer based on the information collected from the multi-function printer, and one or more of the user attributes collected from the user, and the information extracted from the printed document.

In accordance with another exemplary embodiment, a non-transitory computer readable medium (CRM) storing computer program code executed by a computer processor that performs a process of securing printed documents from being scanned or copied on a multi-function printer is disclosed, the process comprising: collecting user attributes from a user upon accessing the multi-function printer; collecting information from the multi-function printer; extracting information from a printed document being scanned or copied; analyzing the user attributes collected from the user, the information collected from the multi-function printer, and the information extracted from the printed document; and determining whether the user is authorized to execute a scan job or a copy job of the printed document on the multi-function printer based on the information collected from the multi-function printer, and one or more of the user attributes collected from the user, and the information extracted from the printed document.

In accordance with an exemplary embodiment, a system is disclosed for securing printed documents from being scanned or copied on a multi-function printer, the system comprising: one or more multi-function printers, each of the one or more multi-function printers having at least a scan function and a copy function; a server having a memory and a processor, the processor configured to: collect user attributes from a user upon accessing the one or more multi-function printers; collect information from the one or more multi-function printers; extract information from a printed document being scanned or copied; analyze the user attributes collected from the user, the information collected from the one or more multi-function printers, and the information extracted from the printed document; and determine whether the user is authorized to execute a scan job or a copy job of the printed document on the one or more multi-function printers based on the information collected from the one or more multi-function printers, and one or more of the user attributes collected from the user, and the information extracted from the printed document.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a multi-function printer (MFP) in accordance with an exemplary embodiment.

FIG. 2 is an illustration of a system for secure scan and/or copy in accordance with an exemplary embodiment.

FIG. 3 is an illustration of a multi-function printer (MFP) and a server, wherein the server has a server program configured to execute a secure scan and/or copy program in accordance with an exemplary embodiment.

FIG. 4 is an illustration of a flow chart illustrating a method of secure scan and/or copy in accordance with an exemplary embodiment.

FIG. 5 is an illustration of a flow chart illustrating a method of secure scan and/or copy in accordance with another exemplary embodiment.

FIG. 6 is an illustration of a flow chart illustrating a method of secure scan and/or copy in accordance with another exemplary embodiment.

FIG. 7 is an illustration of a flow chart illustrating a method of secure scan and/or copy in accordance with another exemplary embodiment.

FIGS. 8-11 is a database of users, printers, and recipients, and corresponding output from the printer manager for a plurality of users and historical information for the plurality of users in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

It would be desirable to have a method and system that provides secure scan and/or copy and which reduces potential security risks on multi-function printers by having automatic action to document/prompt operator action before scan/copy, and which includes automatically updating a users' security level after each scan/copy operation is performed. For example, the changing of a security level for a user can be based upon reaching a predetermined level upon the scanning or copying of the printed document on the multi-function printer for one or more user attributes of the user. For example, the predetermined level can be based on a number of printed documents being scanned or copied by a user within a set period of time, for example, if the user exceeds a preset limit of scans or copies based on the user's history and corresponding user attributes, the user may present a security risk based on the abnormal behavior of excess scanning or copying.

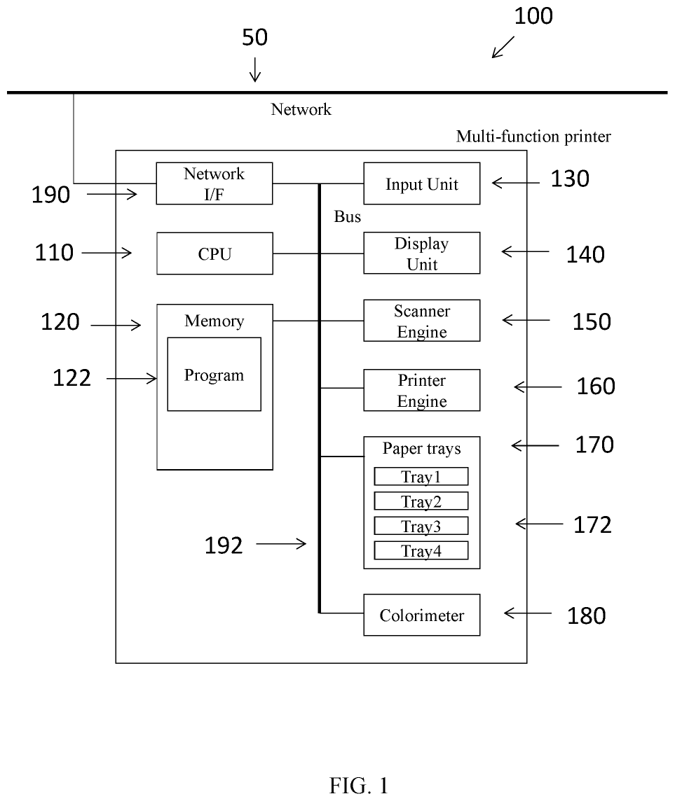

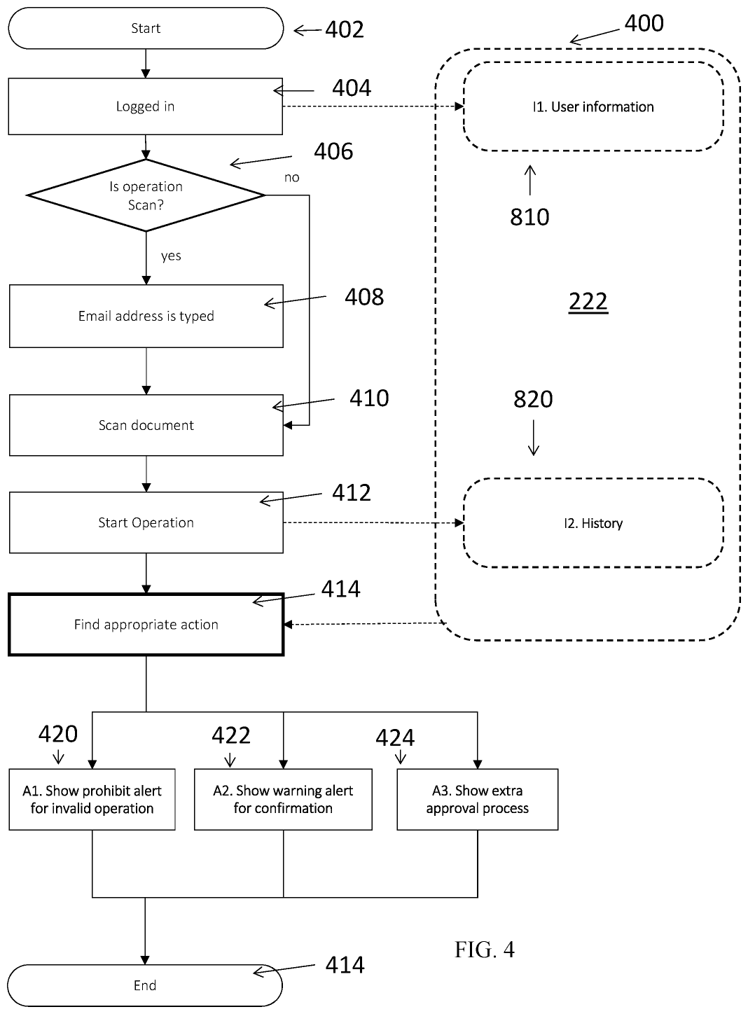

FIG. 1 is an illustration of a multi-function printer 100 in accordance with an exemplary embodiment. As shown in FIG. 4, the multi-function printer 100 can include a network interface (I/F) 190, which is connected to the communication network (or network) 50, a processor or central processing unit (CPU) 110, and one or more memories 120 for storing software programs and data (such as files to be printed) 122. For example, the software programs 122 can include a printer controller and a tray table. The processor or CPU 110 carries out the instructions of a computer program, which operates and/or controls at least a portion of the functionality of the multi-function printer 100. The multi-function printer 100 can also include an input unit (for example, a keypad) 130, a display unit or graphical user interface (GUI) 140, a scanner engine (or scanner) 150, a printer engine 160, a plurality of paper trays 170, and a colorimeter 180. In accordance with an exemplary embodiment, the display unit or GUI 140 can be an interactive screen or touchscreen. The interactive screen or touchscreen can receive user input through simple or multi-touch gestures by touching the screen as well as an output device for displaying content, for example, an alert as disclosed herein.

In accordance with an exemplary embodiment, the colorimeter 180 can be an inline colorimeter (ICCU) (or spectrophotometer), which measures printed color patches in order to generate color profiles. In accordance with an exemplary embodiment, for example, the colorimeter (or spectrophotometer) 180 can be one or more color sensors or colorimeters, such as an RGB scanner, a spectral scanner with a photo detector or other such sensing device known in the art, which can be embedded in the printed paper path, and an optional finishing apparatus or device (not shown). A bus 192 can connect the various components 110, 120, 130, 140, 150, 160, 170, 180, and 190 within the multi-function printer 100. The multi-function printer 100 also includes an operating system (OS), which manages the computer hardware and provides common services for efficient execution of various software programs. In accordance with an exemplary embodiment, it can be within the scope of the disclosure for the multi-function printer 100 to be a copier.

For example, in accordance with an exemplary embodiment, an image processing section within the multi-function printer 100 can carry out various image processing under the control of a print controller or CPU 110, and sends the processed print image data to the print engine 160. The image processing section can also include a scanner section (scanner engine 150) for optically reading a document, such as an image recognition system. The scanner section receives the image from the scanner engine 150 and converts the image into a digital image. The print engine 160 forms an image on a print media (or recording sheet) based on the image data sent from the image processing section. The central processing unit (CPU) (or processor) 110 and the memory 120 can include a program for RIP processing (Raster Image Processing), which is a process for converting print data included in a print job into Raster Image data to be used in the printer or print engine 160. The CPU 110 can include a printer controller configured to process the data and job information received from one or more client computers (not shown) for example, received via the network connection unit and/or input/output section (I/O section) 190.

The CPU 110 can also include an operating system (OS), which acts as an intermediary between the software programs and hardware components within the multi-function printer. The operating system (OS) manages the computer hardware and provides common services for efficient execution of various software applications. In accordance with an exemplary embodiment, the printer controller can process the data and job information received from the one or more client computers to generate a print image.

In accordance with an exemplary embodiment, the network I/F 190 performs data transfer with the server 200, and optionally, the one or more client devices. The printer controller can be programmed to process data and control various other components of the multi-function printer to carry out the various methods described herein. In accordance with an exemplary embodiment, the operation of printer section commences when the printer section receives a page description from the server 200, and the one or more client devices via the network I/F 190 in the form of a print job data stream and/or fax data stream. The page description may be any kind of page description languages (PDLs), such as PostScript® (PS), Printer Control Language (PCL), Portable Document Format (PDF), and/or XML Paper Specification (XPS). Examples of multi-function printer 100 consistent with exemplary embodiments of the disclosure include, but are not limited to, a multi-function printer (MFP), a laser beam printer (LBP), an LED printer, a multi-function laser beam printer including copy function.

In accordance with an exemplary embodiment, the multi-function printer 100 can also include at least one auto tray or paper tray 170, and more preferably a plurality of auto trays or paper trays. Each auto tray or paper tray 170 can include a bin or tray, which holds a stack of a print media (not shown), for example, a paper or a paper-like product. The printer engine or print engine 160 has access to a print media of various sizes and workflow for a print job, which can be, for example, stored in the input tray. A “print job” or “document” can be a set of related sheets, usually one or more collated copy sets copied from a set of original print job sheets or electronic document page images, from a particular user, or otherwise related.

In accordance with an exemplary embodiment, the print media is preferably a paper or paper-like media having one or more print media attributes. The print media attributes can include, for example, paper color, coating, grain direction, printing technology, brightness, CIE, tint, whiteness, labColor, etc. In order to maximize print quality, the print media attributes of each type of print media should be input into or hosted on the multi-function printer 100, for example, on printer configuration settings of the multi-function printer 100 to obtain the highest quality output. Most print media is provided in reams or other known quantities, which are packaged with indicia such as information on the manufacture, size, type and other attributes of the print media. In addition, most bundles or reams of paper include a UPC (Universal Product Code) or bar code, which identifies the type of print media including manufacture of the print media.

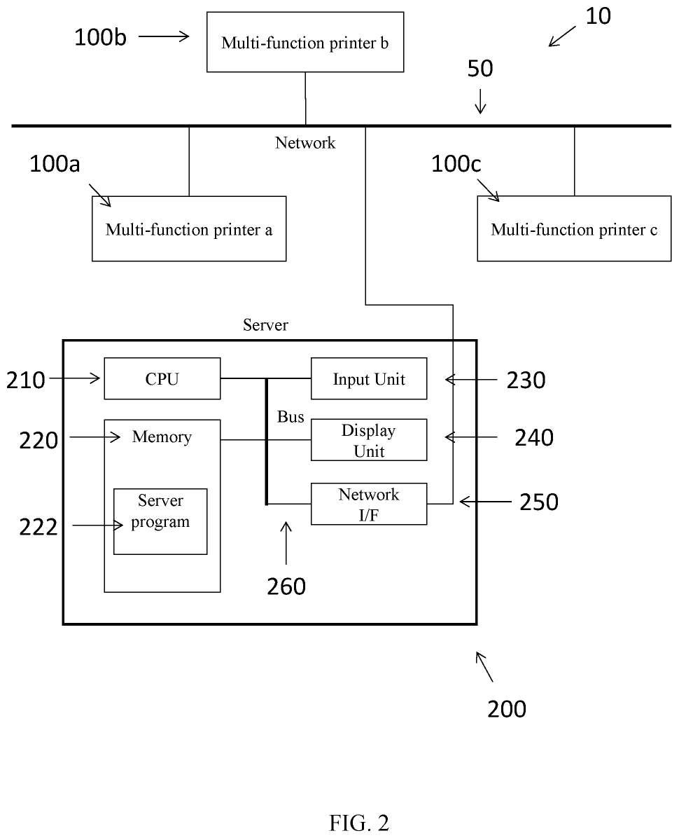

FIG. 2 is an illustration of a system 10 for secure scan and/or copy in accordance with an exemplary embodiment. As shown in FIG. 2, the system 100 includes one or more multi-function printers 100a, 100b, 100c, and a server 200, for example, a central server, which are connected to one another via a communication network 50. As set forth herein, the server 200 can be in communication with one or more multi-function printers 100a, 100b, 100c, and can be configured to execute a program 222 with secure scan and copy as disclosed herein. In accordance with an exemplary embodiment, the system 10 includes a single (or central) server 200, which is configured to manage a plurality of multi-function printers 100a, 100b, 100c, and corresponding users, for example, within a company, at a single location and/or a plurality of locations.

In accordance with an exemplary embodiment, the communication network or network 50 can be a public telecommunication line and/or a network (for example, LAN or WAN). Examples of the communication network 50 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

In accordance with an exemplary embodiment, as shown in FIG. 2, the one or more servers 200 can include a processor or central processing unit (CPU) 210, and one or more memories 220 for storing software programs and data, which can include a dashboard server program 222. The processor or CPU 220 is configured to carry out the instructions of a computer program, which operates and/or controls at least a portion of the functionality of the server 200. The server 200 can also include an input unit 230, a display unit or graphical user interface (GUI) 240, and a network interface (I/F) 250, which is connected to a communication network (or network) 50. A bus 260 can connect the various components 210, 220, 230, 240, and 250 within server 200. The server 200 also includes an operating system (OS), which manages the computer hardware and provides common services for efficient execution of various software programs as disclosed herein.

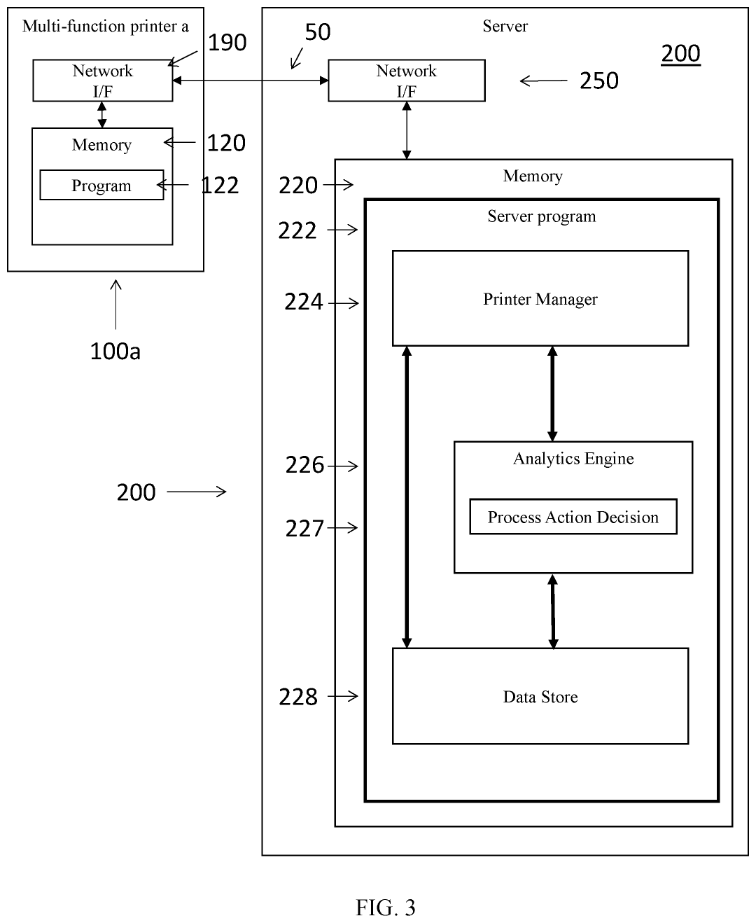

FIG. 3 is an illustration of a multi-function printer (MFP) 100 and a server 200, wherein the server has a server program 222 configured to execute a secure scan and/or copy program for a plurality of multi-function printers (MFP) 100 in accordance with the embodiments as disclosed herein. As shown in FIG. 3, the multi-function printer 100a is in communication with the sever 200 via the communication network 50. The server 200 includes a memory 220 having a server program 222. The server program 222 includes a printer manager 224, an analytics engine 226 having a process action decision program 227, and a data store (or data storage) 228. The server program 222 can be stored in a multi-function printer.

In accordance with an exemplary embodiment, the printer manager 224 can be configured to collect user attributes from a user upon accessing the multi-function printer, collect information from the multi-function printer, and extracting information from a printed document being scanned or copied. The analytics engine 226 is configured to analyze the user attributes collected from the user, the information collected from the multi-function printer 100, and the information extracted from the printed document, and determining whether the user is authorized to execute a scan job or a copy job of the printed document on the multi-function printer based on the information collected from the multi-function printer, and one or more of the user attributes collected from the user, and the information extracted from the printed document. In accordance with an exemplary embodiment, the printed document can be any document, which can be scanned or copied on a multi-function printer (MFP), for example, a financial report, a business plan, a document containing confidential information, and/or medical records.

In accordance with an exemplary embodiment, the process action decision 227 can be configured to carry out the step of determining whether the user is authorized to execute a scan job or a copy job of the printed document on the multi-function printer based on the information collected from the multi-function printer, and one or more of the user attributes collected from the user, and the information extracted from the printed document.

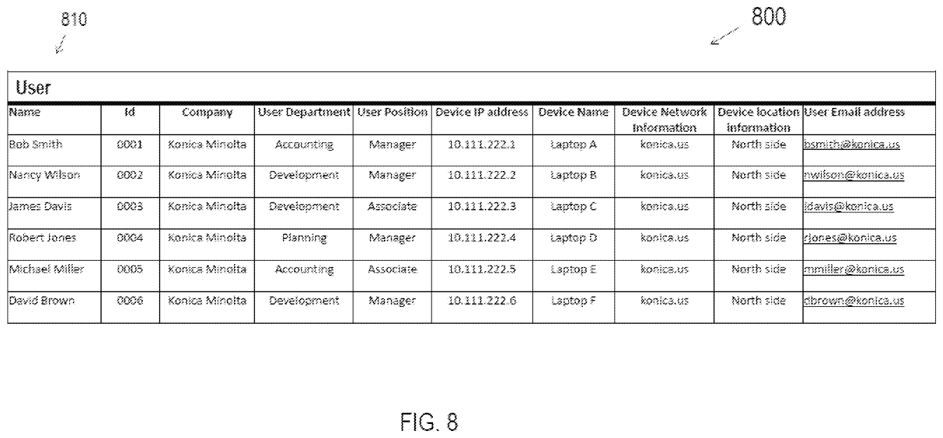

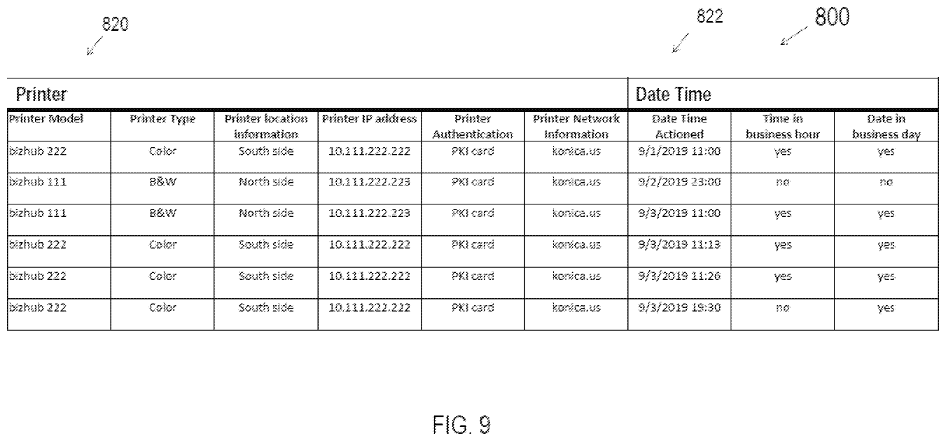

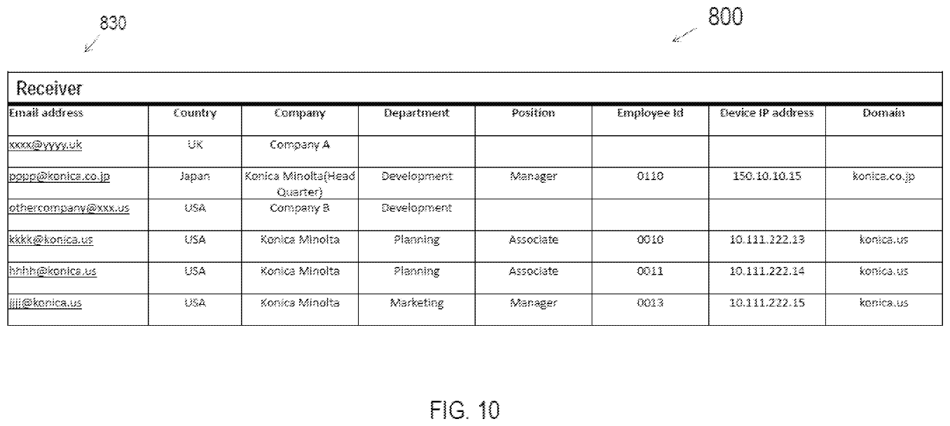

In accordance with an exemplary embodiment, the data store or data storage 228 can be configured to host a database of information on users 810 (FIG. 8), multi-function printers 820 (FIG. 9), and receivers or recipients 830 (FIG. 10), which is retrieved by the analytics engine 226 to determine if the scan job or copy job should be executed and/or an alert provided to the user in accordance with the embodiments disclosed herein.

FIG. 4 is an illustration of a flow chart 400 illustrating a method of secure scan and/or copy in accordance with an exemplary embodiment. As shown in FIG. 4, the process starts in step 402. In step 404, the user logs into the multi-function printer 404, for example, by username and password, or other known method, which authenticates a user, for example, username and/or by a biometric such as a fingerprint, palm veins, face recognition, DNA, palm print, hand geometry, iris recognition, and/or retina, or other authentication protocol. During the step of logging into (or being authenticated on) the multi-function printer 100 via, for example, the input unit 130 or display unit 140, information associated with the user, for example, the user credentials are input into the user information section 810 of the server program 222.

In accordance with an exemplary embodiment, the user information 810 can include information relating to the sender of the scan job or user wishing to copy a printed document, and information corresponding to the user, for example, employer or division within the company in which the user is associated, and/or the position or title of the user, and/or who is the supervisor of the user . For example, if the user is in a sales or financial position within a company or business, the user may have been authorized to send a scan job or execute a copy job. Alternatively, if the user is in the research and development (R&D) and/or human resources, for example, the user is an administrative assistant in the R&D department, the user may not be able to execute a scan job or a copy job as an administrative assistant in the sales or finance department.

Once the user has logged in or been authenticated in step 404, in step 406, a determination is made if the operation to be performed on the multi-function printer 100 is a scan job (or scan operation). If the operation is not a scan job, the process continues to step 412 to start the operation, for example, a copy job. If the operation in step 406 is a scan job, the process continues to step 408 wherein the e-mail address of the recipient (i.e., receiver) of the scan job is input into the input unit 130 and/or display unit 140 on the multi-function printer 100. In step 410, the document and/or documents are digitized by the scanner engine 150.

In accordance with an exemplary embodiment, the user attributes collected from the user includes classifying the user as an internal user or an external user, the internal user having one or more known user attributes and the external user having no known user attributes in the database. In accordance with an exemplary embodiment, for example, the external user may be granted printing privileges on the multi-function printer 100, and restricted from scan or copy operations on the multi-function printer 100 for improved security. For example, in accordance with an exemplary embodiment, the external user may a guest to a company or business, and it would be in the best interest of the company or business for security reasons to prevent the external user from having access to the scan and/or copy functions on the multi-function printer 100 until users attributes for the external user are input into the database and the guest is reclassified as an internal user with scan and/or copy privileges.

In step 412, an operation is selected by the user on the multi-function printer 100. The selected operations can include, for example, copy and/or scan. Once the operation has been selected, the type of operation is input into the history section 820 of the server program 222. In accordance with an exemplary embodiment, the selection of the operation in step 412, i.e., scan and/or copy triggers the process as disclosed to check the current information with a past history, for example, for the user.

In accordance with an exemplary embodiment, the history section 820 of the server program 222 is configured to receive information related to the multi-function printer 100 and the operation that is being requested by the user. For example, the history section 820 can receive information on the multi-function printer, for example, type of multi-function printer (i.e., color or B&W (black and white), number of copies requested (for example, for a copy job including size of the copy job (i.e., 1 copy, 5 copies, 20 copies, 100 copies, etc.)), and information related to the receiver of the operation, for example, IP address of the recipient or receiver. In accordance with an exemplary embodiment, the database hosted within the data storage (i.e., data store) 228 within the server can include information which can be used to determine the receiver, for example, of a scan job, including geographical location (i.e., country or region of the world), company or business, and information relating to job titles and/or positions within companies or businesses based on publically available information and/or information previous sent to and/or received from the receiver or recipient.

In addition, the history section 820 can optionally include information about the user and previous scan jobs and/or copy jobs, which may or may not establish a behavioral pattern. For example, the history section 820 can include information that identifies that a user has previously, for example, sent a scan job to one or more receivers, or executed a copy job, for example, in a certain number of copies and/or a certain time of the day, month, and/or year, which establishes a pattern that the analytics engine 226 can consider in authorizing and/or denying an operation on the multi-function printer 100 by one or more users.

In accordance with an exemplary embodiment, the data store or data storage 228 is configured to host a database of users, the database of users including one or more user attributes for each of the users. In addition, the database can be automatically updated for the one or more user attributes of the user upon the printed document being scanned or copied on the multi-function printer 100.

In step 414, the server program 222 processes the user information 810 and the history information 820, and based on the user and the type of operation being performed by the user, the server program 222 can output one or more options 420, 422, 424, which is displayed on the display unit 140 of the multi-function printer 100. For example, the one or more options 420, 422, 424 can include “show prohibit alert for invalid operation” (i.e., operation is prohibited) 420, “show warning alert for confirmation” (i.e., operation is allowed based on one or more exceptions, for example, the geographical location or region (i.e., country) is prohibited), however, the receiver is a known receiver and/or is a company or employee of a company in which the operation is permitted) 422, or show “extra approval process required” (i.e., the user is not authorized to perform the operation without approval from another user, for example, a manager and/or a supervisor) 424. The process ends in step 416.

In accordance with an exemplary embodiment, for example, if the user is attempting to scan a document and forward the document to an email address having a foreign domain, for example, “xxxx@yyy.uk”, the output on the display unit 140 may be indicate that the document cannot be scanned and sent to the recipient (i.e., alert for invalid operation 420) since the recipient's e-mail address is in a country (i.e., United Kingdom) in which information, for example, confidential information and/or documents cannot be sent from the user and/or company.

In accordance with another exemplary embodiment, for example, if the user is attempting to scan a document and forward the document to an email address having a foreign domain, for example, pppp@konica.co.jp, which reflects a foreign country (i.e. Japan) which is permitted. However, the user receives a warning or alert that confirms that the operation is permitted with an indication that the recipient's e-mail is a foreign e-mail address. For example, the warning alert 422 can indicate that the recipient's e-mail address is a foreign address, however, the country and/or recipient is acceptable and/or permitted based on company policy and/or the identity of the receiver.

In accordance with a further exemplary embodiment, for example, if the user is attempting to scan a document and forward the document to an email address having an e-mail address associated with a user, a company or other particulars, for example, a database of e-mail addresses, which has been documented to require the user (i.e., for example, an associate), without approval by a manager and/or specified user and/or user (i.e., extra approval process 424). For example, the user may need to obtain approval of sales number or confidential information from a manager or divisional manager.

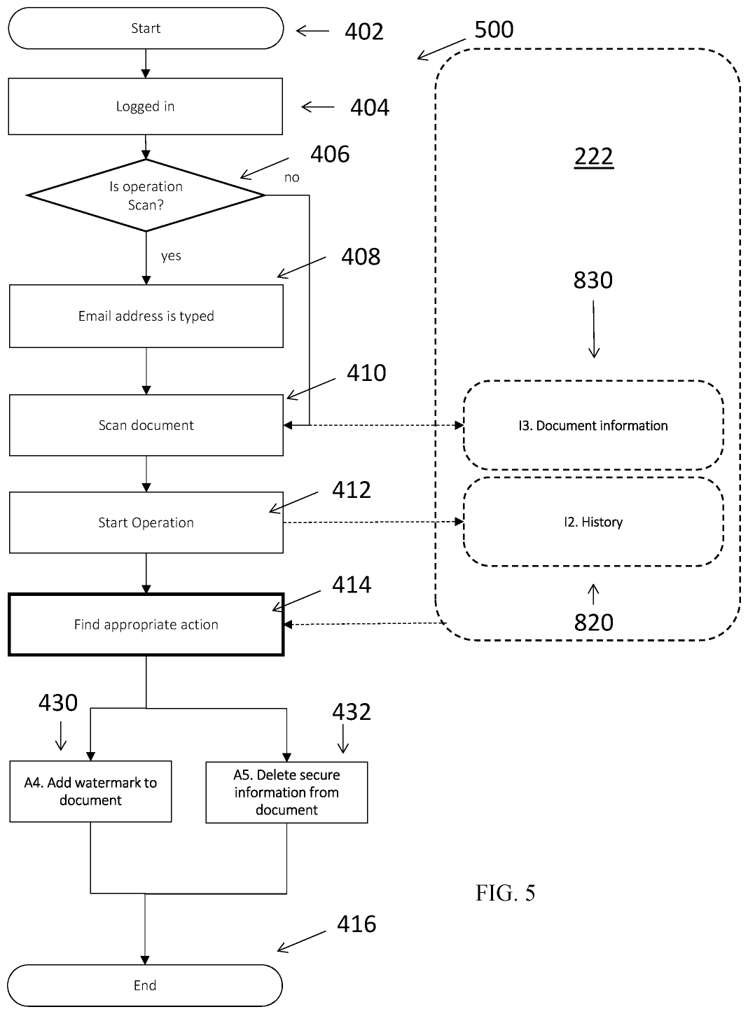

FIG. 5 is an illustration of a flow chart 500 illustrating a method of secure scan and/or copy in accordance with another exemplary embodiment. As shown in FIG. 5, the process starts in step 402. In step 404, the user logs into the multi-function printer 404, for example, by username and password, or other known method, which authenticates a user, for example, username and/or by a biometric such as a fingerprint, palm veins, face recognition, DNA, palm print, hand geometry, iris recognition, and/or retina, or other authentication protocol.

Once the user has logged in or been authenticated in step 404, in step 406, a determination is made if the operation to be performed on the multi-function printer 100 is a scan. If the operation is not a scan job, the process continues to step 412 to start the operation, for example, a copy. If the operation in step 406 is a scan job, the process continues to step 408 wherein the e-mail address of the recipient of the scan job is input into the multi-function printer 100. In step 410, the document and/or documents are digitized by the scanner engine 150. During the digitization of the document and/or documents, the document and/or documents and the corresponding digitization, digital image, and/or data are sent to the document information portion 830 of the sever program 222 on the server 220.

In accordance with an exemplary embodiment, the document information portion 830 receives the digital image and/or data and based on the digital image and/or data, the analytics engine 226 can recognize, for example, similar content or predetermined words, phrases, textual patterns, for example, columns and/or rows of number indicative of sales numbers, excessive numbers arranged in patterns, which can also be indicative of sales number, key individuals or executives identified in the digital image and/or data, format, file properties (i.e., type of document, Word®, Power Point®, or Microsoft Excel®, which may or may not be indicative of the type of document, for example, a Power Point or Excel spread sheet may be more likely to contained confidential information than a Word document), and/or file size.

In step 412, an operation is selected by the user on the multi-function printer 100. The selected operations can include, for example, copy (i.e. copy job) and/or scan (i.e., scan job). Once the operation has been selected, the type of operation is input into the history section 820 of the server program 222. In step 414, the server program 222 processes the history information 820 and the document information 830 and outputs one or more options 430, 432 on the display unit 140 of the multi-function printer 100. For example, the one or more options can include adding a watermark to the document 430, and/or deleting secure information form document 432, for example, if the analytics engine 226 determines that executing the operation may present a risk to the company and/or that the scan or copy of the printed document should be identified as containing secure or confidential information so that the documents are handled with the appropriate care to protect the company for undesirable risks and/or exposure from careless and/or intentional conduct of employees and/or receivers of the documents. The process ends in step 416.

In accordance with an exemplary embodiment, the program server 222, for example, can output that the documents and/or documents that include a watermark 430 that has automatically been added to the document, which identifies the document as “Confidential” or “Contains Sensitive Information”. In accordance with an exemplary embodiment, the watermark can be any identifying image or pattern that appears as various shades of lightness/darkness and conveys a message, for example, “Confidential”, “Contains Sensitive Information”, which can be applied to documents that pertain to financial documents of a company or business, planning documents including potential acquisitions or mergers, sales and/or revenue forecasts or projections, and/or personal information that are of a sensitive nature, for example, social security numbers, banking records, and/or medical records.

In accordance with an exemplary embodiment, the user can be prompted on the display unit 140 that the document contains sensitive or secure information and that a watermark 430 will be added to the document prior to the digital image be sent. In addition, the multi-function printer 100 can display a request on the display unit requesting confirmation from the user that the watermark is to be added or placed on the scanned or printed document, or alternatively, the user can be given the option to cancel the scan operation or copy operation.

In accordance with another exemplary embodiment, the program server 222 can output that the documents contains secure information 432, for example, confidential or sensitive information that needs to be deleted from the document and the program server 222 can proceed, for example, automatically, to delete the secure information prior to the document being sent.

In accordance with an exemplary embodiment, the user can be prompted on the display unit 140 that the document contains sensitive or secure information and that the sensitive or secure information will be deleted from the document prior to the digital image being sent, and request confirmation from the user that the program server 222 will delete the sensitive or secure information, or alternatively, give the user the option to cancel the request to send the scanned document.

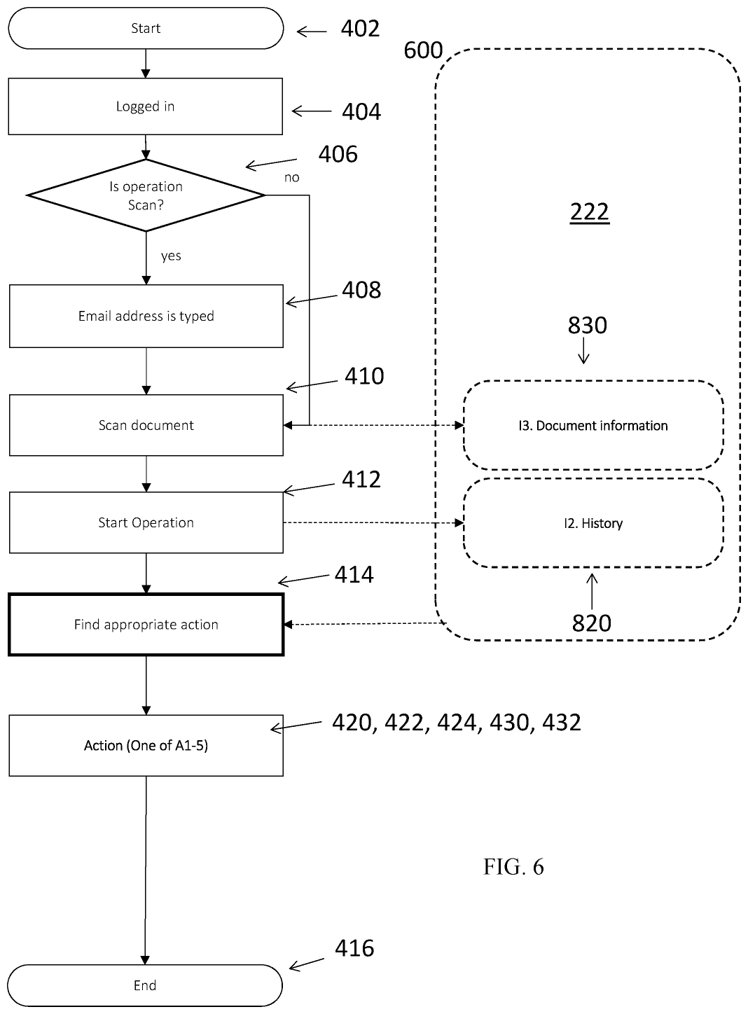

FIG. 6 is an illustration of a flow chart 600 illustrating a method of secure scan and/or copy in accordance with another exemplary embodiment. As shown in FIG. 6, the process starts in step 402. In step 404, the user logs into the multi-function printer 404, for example, by username and password, or other known method, which authenticates a user, for example, by username and/or a biometric such as a fingerprint, palm veins, face recognition, DNA, palm print, hand geometry, iris recognition, and/or retina, or other authentication protocol.

Once the user has logged in or been authenticated in step 404, in step 406, a determination is made if the operation to be performed on the multi-function printer 100 is a scan job. If the operation is not a scan job, the process continues to step 412 to start the operation, for example, a copy job. If the operation in step 406 is a scan job, the process continues to step 408 wherein the e-mail address of the recipient of the scan job is input into the multi-function printer 100 via the input unit 130 or display unit 140. In step 410, the document and/or documents are digitized by the scanner engine 150. During the digitization of the document and/or documents, the document and/or documents and the corresponding digitization, digital image, and/or data are sent to the document information portion 830 of the sever program 222 on the server 220.

In step 412, an operation is selected by the user on the multi-function printer 100. The selected operations can include, for example, copy, scan, and/or print. Once the operation has been selected, the type of operation is input into the history section 820 of the server program 222. In step 414, the server program 222 processes the history information 820 and the document information 830 and outputs one or more options 420, 422, 424, 430, 432, on the display unit 140 of the multi-function printer 100. For example, the one or more options can include show prohibit alert for invalid operation 420, show warning alert for confirmation 422, or show extra approval process 424, add a watermark to the document 430, and/or delete secure information form document 432. The process ends in step 416.

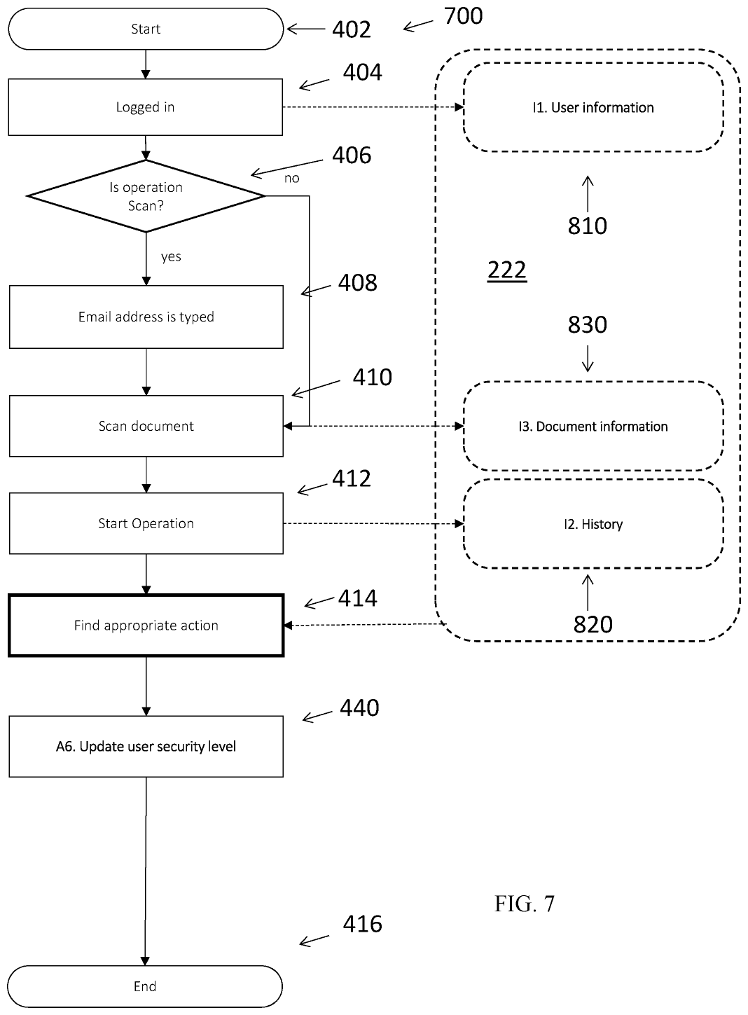

FIG. 7 is an illustration of a flow chart illustrating a method secure scan and/or copy in accordance with another exemplary embodiment. As shown in FIG. 7, the process starts in step 402. In step 404, the user logs into the multi-function printer 404, for example, by username and password, or other known method, which authenticates a user, for example, username and/or by a biometric such as a fingerprint, palm veins, face recognition, DNA, palm print, hand geometry, iris recognition, and/or retina, or other authentication protocol. During the step of logging into the multi-function printer 100, information associated with the user, for example, the user credentials are input into the user information section 810 of the server program 222.

Once the user has logged in or been authenticated in step 404, in step 406, a determination is made if the operation to be performed on the multi-function printer 100 is a scan. If the operation is not a scan job, the process continues to step 412 to start the operation, for example, a copy job. If the operation in step 406 is a scan job, the process continues to step 408 wherein the e-mail address of the recipient of the scan job is input into the multi-function printer 100. In step 410, the document and/or documents are digitized by the scanner engine 150. During the digitization of the document and/or documents, the document and/or documents and the corresponding digitization, digital image, and/or data are sent to the document information portion 830 of the sever program 222 on the server 220.

In step 412, an operation is selected by the user on the multi-function printer 100. The selected operations can include, for example, copy, scan, and/or print. Once the operation has been selected, the type of operation is input into the history section 820 of the server program 222. In step 414, the server program 222 processes the user information 810, the history information 820, and the document information 830, and based on the user information 810, the history information 820, and the document information 830, the server program can update the user's security before the scanned document can be further processed and/or sent, which may prevent the user from being able to forward the document and/or other options as set forth above, for example, show prohibit alert for invalid operation 420, show warning alert for confirmation 422, or show extra approval process 424, add a watermark to the document 430, and/or delete secure information from document 432. The process ends in step 416.

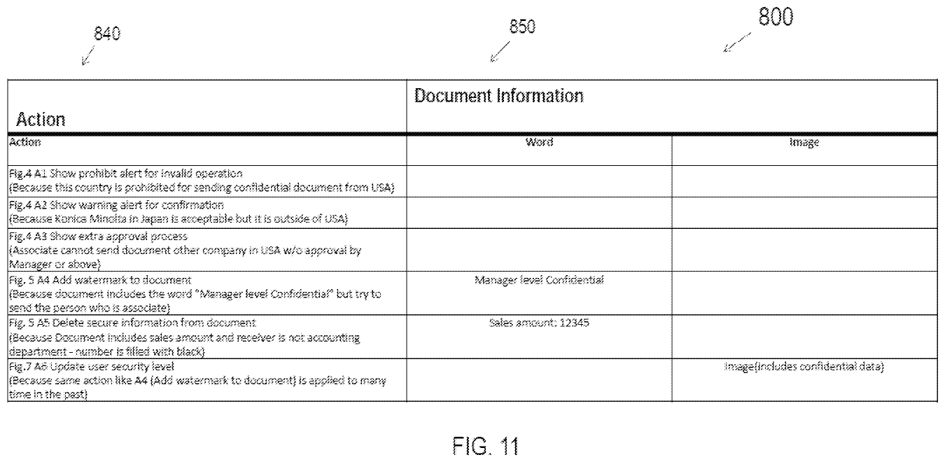

FIGS. 8-11 is a database 800 of users, printers, and recipients, and corresponding output from the printer manager for a plurality of users and historical information for the plurality of users in accordance with an exemplary embodiment. As shown in FIGS. 8-11, the database 800 of user settings can include a plurality of users 810, one or more multi-function printers (100) 820 with corresponding information 822 related to scan and/or copies jobs being executed on the multi-function printers 100, receiver or recipient information 830, action taken 840, and additional document information 850.

In accordance with an exemplary embodiment, the database of users 810 can include, for example, name of user, identifier or Id of the user, company, user department, user position, device IP address, device name (for example, Laptop A), device network information (for example, konica.us), device location information (for example, North side), and user e-mail address.

In accordance with an exemplary embodiment, the database of multi-function printers (100) 820 can include printer model, printer type (for example, color or black and white (B&W)), printer location information, printer IP address, printer authentication (for example, PKI card), printer network information. The corresponding information 822 related to a scan or copy job on a multi-function printer 100 executed by one or more of the plurality of users 810 in the database 800 can include date and time of action, time in business hours (i.e., is the operation being requested during business hours, for example, between 9 am to 5 pm, Yes or No) and date in business week or weekend or holiday (i.e., is the operation being requested on day of the week in which employees are expected to be working, or alternatively, a holiday or weekend, Yes or No).

In accordance with an exemplary embodiment, the receiver or recipient information 830 can include e-mail address, country of e-mail address, company name associated with e-mail address, department of recipient, position of recipient, employee Identifier or ID of recipient, device IP address of recipient, and domain of e-mail address of the recipient of the document, for example, a scanned document from one or more of the users 810.

In accordance with an exemplary embodiment, the list of actions 840 and document information 850 can include show prohibit alert for invalid operation (i.e., because country of recipient is prohibited from sending confidential document from user, for example, located in United States (FIG. 4, A1) 420), show warning alert for confirmation (because Konica Minolta in Japan is acceptable or approved, but since Konica Minolta is outside of the United States (FIG. 4, A2) 422), show extra approval process (i.e., associate cannot send document to another company in United States without approval from a manager or above (FIG. 4, A3) 424), add watermark to document (i.e., because document includes the word “Manager Level Confidential” and person trying to send the document is an associate (FIG. 5, A4) 430), delete secure information from document (i.e., document includes sales amount and recipient is not accounting department—sales numbers can be removed or filled with black (FIG. 5, A5) 432), and update user security level (i.e., same action as A4, 430, add watermark to document, to many documents being sent by user and the document includes images with confidential data (FIG. 7, A6), 440).

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of securing printed documents from being scanned or copied on a multi-function printer, the method comprising:
collecting user attributes from a user upon accessing the multi-function printer;
collecting information from the multi-function printer;
extracting information from a printed document being scanned or copied;
analyzing the user attributes collected from the user, the information collected from the multi-function printer, and the information extracted from the printed document; and
determining whether the user is authorized to execute a scan job or a copy job of the printed document on the multi-function printer based on the information collected from the multi-function printer, and one or more of the user attributes collected from the user, and the information extracted from the printed document.

2. The method according to claim 1, wherein the determination of whether the user is authorized to execute the scan job or the copy job further comprises:
alerting the user that the user is prohibited from executing the scan job or the copy job;
alerting the user that the user is authorized to execute the scan job or the copy job;
requiring the user to obtain approval before the scan job or the copy job can be executed;
adding a watermark to the scan job or the copy job before the scan job or copy job can be executed; and/or
deleting information from the scan job or the copy job before the scan job or the copy job can be executed.

3. The method according to claim 1, further comprising:
displaying on a display unit of the multi-function printer one or more of the following:
an alert that the user is prohibited from executing the scan job or the copy job;
an alert that the user is authorized to execute the scan job or the copy job; and/or
a request for the user to obtain approval before the scan job or the copy job can be executed.

4. The method according to claim 1, wherein the determination of whether the user is authorized to execute the scan job or the copy job further comprises:
updating a security level of the user before the scan job or the copy job can be executed, and wherein the updated security level results in adding a watermark to the scan job or the copy job before the scan job or copy job can be executed, and/or deleting information from the scan job or the copy job before the scan job or the copy job can be executed.

5. The method according to claim 1, wherein the user attributes collected from the user comprises:
assigning a security level to each of the one or more users, the security level defining types of documents that can be scanned or copies by each of the one or more users.

6. The method according to claim 1, wherein the user attributes collected from the user comprises:
classifying the user as an internal user or an external user, the internal user having one or more known user attributes and the external user having no known user attributes;
allowing the external user printing privileges on the multi-function printer; and
restricting the external user from scan or copy operations on the multi-function printer.

7. The method according to claim 1, wherein,
the collected user attributes comprises one or more of the following:
user name, employer of user, department of user within employer, and user e-mail address; and
the information collected from the multi-function printer comprises:
a type of multi-function printer for the copy job or a destination IP address for the scan job.

8. The method according to claim 7, wherein the determination of whether the user is authorized to execute the scan job is based on the destination IP address of a recipient of the scan job.

9. The method according to claim 8, wherein the destination IP address of the recipient of the scan job includes one or more of a geographical location and/or a company name.

10. The method according to claim 1, further comprising:
classifying the printed document as containing confidential information and sales numbers when comparing objects in the printed document to objects in a database that contain one or more words, a combination of words and numbers, and/or a pattern containing numbers and/or words that is determined by an analytic engine to represent a confidential document.

11. The method according to claim 1, further comprising:
hosting a database of users, the database of users including one or more user attributes for each of the users; and
automatically updating the one or more user attributes of the user upon the printed document being scanned or copied on the multi-function printer.

12. The method according to claim 11, further comprising:
changing a security level for the user when the one or more user attributes of the user reach a predetermined level upon the scanning or copying of the printed document on the multi-function printer.

13. The method according to claim 1, wherein the predetermined level is based on a number of printed documents being scanned or copied by a user within a set period of time.

14. A non-transitory computer readable medium (CRM) storing computer program code executed by a computer processor that performs a process of securing printed documents from being scanned or copied on a multi-function printer, the process comprising:
collecting user attributes from a user upon accessing the multi-function printer;
collecting information from the multi-function printer;
extracting information from a printed document being scanned or copied;
analyzing the user attributes collected from the user, the information collected from the multi-function printer, and the information extracted from the printed document; and
determining whether the user is authorized to execute a scan job or a copy job of the printed document on the multi-function printer based on the information collected from the multi-function printer, and one or more of the user attributes collected from the user, and the information extracted from the printed document.

15. The computer readable medium according to claim 14, wherein the determination of whether the user is authorized to execute the scan job or the copy job further comprises:
alerting the user that the user is prohibited from executing the scan job or the copy job;
alerting the user that the user is authorized to execute the scan job or the copy job;
requiring the user to obtain approval before the scan job or the copy job can be executed;
adding a watermark to the scan job or the copy job before the scan job or copy job can be executed; and/or
deleting information from the scan job or the copy job before the scan job or the copy job can be executed.

16. The computer readable medium according to claim 14, wherein the determination of whether the user is authorized to execute the scan job or the copy job further comprises:
updating a security level of the user before the scan job or the copy job can be executed, and wherein the updated security level results in adding a watermark to the scan job or the copy job before the scan job or copy job can be executed, and/or deleting information from the scan job or the copy job before the scan job or the copy job can be executed.

17. A system for securing printed documents from being scanned or copied on a multi-function printer, the system comprising:
one or more multi-function printers, each of the one or more multi-function printers having at least a scan function and a copy function;
a server having a memory and a processor, the processor configured to:
collect user attributes from a user upon accessing the one or more multi-function printers;
collect information from the one or more multi-function printers;
extract information from a printed document being scanned or copied;
analyze the user attributes collected from the user, the information collected from the one or more multi-function printers, and the information extracted from the printed document; and
determine whether the user is authorized to execute a scan job or a copy job of the printed document on the one or more multi-function printers based on the information collected from the one or more multi-function printers, and one or more of the user attributes collected from the user, and the information extracted from the printed document.

18. The system according to claim 17, wherein the determination of whether the user is authorized to execute the scan job or the copy job further comprises:
alerting the user that the user is prohibited from executing the scan job or the copy job;
alerting the user that the user is authorized to execute the scan job or the copy job;
requiring the user to obtain approval before the scan job or the copy job can be executed;
adding a watermark to the scan job or the copy job before the scan job or copy job can be executed; and/or
deleting information from the scan job or the copy job before the scan job or the copy job can be executed.

19. The system according to claim 17, further comprising:
a display unit on the multi-function printer configured to display one or more of the following:
an alert that the user is prohibited from executing the scan job or the copy job;
an alert that the user is authorized to execute the scan job or the copy job; and/or
a request for the user to obtain approval before the scan job or the copy job can be executed.

20. The system according to claim 17, wherein the determination of whether the user is authorized to execute the scan job or the copy job further comprises:
updating a security level of the user before the scan job or the copy job can be executed, and wherein the updated security level results in adding a watermark to the scan job or the copy job before the scan job or copy job can be executed, and/or deleting information from the scan job or the copy job before the scan job or the copy job can be executed.
